(19) United States
(12) Patent Application Publication
(10) Pub. No.: US 2021/0166722 A1
(43) Pub. Date: Jun. 3, 2021

(54) A SYSTEM FOR DETERMINING AN EMOTIONAL STATE OF A SUBJECT

(71) Applicant: FUTURE FRAGMENT (PTY) LTD, Centurion, Pretoria (ZA)

(72) Inventors: Deon TALJAARD, Centurion, Pretoria (ZA); Stuart Robert JACOBS, Centurion, Pretoria (ZA)

(21) Appl. No.: 17/047,228

(22) PCT Filed: Apr. 11, 2019
(86) PCT No.: PCT/ZA2019/050019

§ 371 Date: Oct. 13, 2020

(30) Foreign Application Priority Data
Apr. 11, 2018 (ZA) 2018/02357

(51) Int. Cl. G10L 25/63; G10L 15/18; G10L 15/197

(52) U.S. Cl. CPC G10L 25/63; G10L 15/197; G10L 15/1807

(57) ABSTRACT

A system for determining an emotional state of a subject includes a speech sensor for sensing a subject's speech, a receiving means arranged in communication with the speech sensor for receiving the sensed speech, a converting means for converting the sensed speech into text, a classifying means for classifying the text and speech characteristics of the subject's speech according to a predetermined set of human emotions, and an analysing means for analysing the classified text and speech characteristics so as to determine an emotional state of the subject. The classifying means is configured to compare sensed speech characteristics to characteristic references for allowing a user to determine a change in speech characteristics of the subject's speech relative the characteristic references during a conversation with the subject.

### CROSS-REFERENCE TO RELATED APPLICATIONS

This application is a national-stage entry of PCT/ZA2019/050019, which was filed on Apr. 11, 2019, and claims priority to South African Patent Application No. 2018/02357, which was filed on Apr. 11, 2018. Each of these priority applications is incorporated herein by reference in their entirety.

### TECHNICAL FIELD

This invention relates to a system for determining an emotional state of a subject. In particular, the invention relates to a system for determining an emotional state of a subject through speech of the subject.

### SUMMARY OF THE INVENTION

According to the invention, there is provided a system for determining an emotional state of a subject, which system includes:

a speech sensor for sensing a subject's speech;

a receiving means arranged in communication with the speech sensor for receiving the sensed speech;

a converting means for converting the sensed speech into text;

a classifying means for classifying the text and speech characteristics of the subject's speech according to a predetermined set of human emotions; and

an analysing means for analysing the classified text and speech characteristics so as to determine an emotional state of the subject.

The speech sensor may be in the form of any suitable conventional sound sensor for sensing and converting sound into electrical signals.

The receiving means may be arranged in communication with a data storage means for allowing the sensed speech to be stored and/or captured thereon. The data storage means may be in the form of any one or more of the group including an external hard drive or magnetic type hard drive, a solid-state drive, a network attached storage, a flash or USB drive and an optical drive. The data storage means may include a plurality of buffers which may be configured to receive and/or store the sensed speech. A buffer may have a size so as to be capable of receiving and/or storing all sensed speech of a subject during a conversation between a user and the subject. In particular, the buffers may have a size in the range of 500 000 bytes to 1 070 000 bytes, preferably being 900 000 bytes, for allowing an audio file of duration in the range of 7 seconds to 15 seconds, to be received and/or stored thereon. More particularly, the duration of the audio file may preferably correspond to a duration of a sentence or conversation.

The converting means may be configured to convert the sensed speech into text utilising any suitable conventional speech to text conversion technique or method. In particular, the converting means may be configured to convert the sensed speech into a sequence of words. The converting means may be further configured to continuously convert the sensed speech into text such that an entire conversation between a user and the subject is capable of being converted into text.

A recording means may be arranged in communication with the speech sensor for allowing the sensed speech to be recorded. The recording means may be configured to record and/or monitor, preferably continuously, the speech characteristics of the subject's speech throughout the duration of a conversation with the subject. The speech characteristics may include any one or more of the group including amplitude or loudness, frequency or pitch, inflection, pronunciation, prosody, grammar, and vocabulary. Prosody may typically include patterns of a variety of linguistic nuances such as intonation, tone, emphasis, stress, accent and rhythm. It is to be appreciated that prosody may be specific to a particular subject and may reflect physiological and habitual aspects of the subject. Prosody may further indicate an identity of a subject.

The recording means may be configured to record prosody by extracting any one or more sound features of the group including pitch, amplitude, energy, zero crossing rate, entropy of energy, spectral centroid, spectral entropy, spectral flux, spectral roll-off, mel-frequency cepstral coefficients (MFCCs), chroma vector, chroma deviation, and duration from the sensed speech. Extraction of the sound features by the recording means may be carried out via any suitable extraction method such as, for example, short-term or mid-term feature extraction. It is to be appreciated that short-term feature extraction may be carried out by splitting a sound signal into a plurality of frames and/or segments and measuring aspects of the sound signal in a frame so as to compute and/or extract any one or more of the above features in the frame. Further, mid-term feature extraction may include a statistical analysis of the features extracted during short-term feature analysis. The sound features may be located in a region commonly known in the field as a prosodic contour or boundary. The prosodic contour may extend over a plurality of syllables and may be segmented into pseudo syllabic regions. The pseudo syllabic regions may be modeled using any one or more of the above sound features, preferably being in the form of feature vectors. Feature vectors may be in the form of any one or more of the group including a change in energy, which may be computed using a difference in maximum and minimum energy in a frame, average jitter, which may be computed using the variation in frequency for a particular cycle and average shimmer, which may be computed using a variation in peak-to-peak amplitude. Prosodic contours or boundaries may be in the form of prosodic word boundaries or prosodic phrase boundaries.

The classifying means may be arranged in communication with the converting means for allowing receipt of text therefrom. The classifying means may be configured to classify individual words of the text according to the predetermined set of human emotions. The predetermined set of human emotions may be selected from the group including joy, trust, fear, surprise, sadness, disgust, anger, and anticipation. The predetermined set of human emotions may be based on Robert Plutchik's wheel of emotions.

The classifying means may be configured to classify the words according to a scale which may be adapted to indicate and/or represent correlations between a word and an emotion. The scale may be in the form of a binary scale, preferably having eight digits which may correspond to the predetermined set of eight human emotions. The binary scale may be configured such that a one represents a correlation between the word and the emotion, and a zero represents an absent correlation between the word and the emotion. The scale may include a further two digits for representing sentiment of a particular word. The first digit may represent negative sentiment and the second digit may represent positive sentiment, such that a one indicates a negative and positive sentiment, respectively, and a zero indicates neutral sentiment. More particularly, the classifying means may be configured to classify the words of the text according to the NRC (National Research Council Canada) Word-Emotion Association Lexicon.

The classifying means may be further configured to compare the sensed and/or recorded speech characteristics to characteristic references for allowing a user to determine a change in speech characteristics of the subject's speech relative the characteristic references during a conversation with the subject. The characteristic reference may be an average which may be measured towards a beginning of a conversation with the subject and which may be measured over a predetermined period of time, preferably being thirty seconds. The classifying means may be configured to classify the sensed and/or recorded speech characteristic according to a characteristic scale. The characteristic scale may include three categories, namely, negative, neutral and positive, preferably being represented by the values −1, 0 and 1, respectively, which may indicate a decrease, constant and an increase in the particular speech characteristic, respectively. Speech characteristics such as amplitude and/or frequency may be classified according to such a characteristic scale. The classifying means may be configured to account for characteristics unique to a particular subject. Additionally, the classifying means may be configured to account for a particular audio transmitting device used by the particular subject. Alternatively, the characteristic reference may be in the form of characteristic patterns which may be specific to a particular subject, which patterns may be measured and recorded during conversation with the subject.

The analysing means may be arranged in communication with the classifying means for allowing receipt of the classified text and speech characteristics therefrom. The analysing means may be configured to input the classified text and speech characteristics into a statistical model for determining and/or calculating the emotional state of the subject at any given time during a conversation with the subject. The statistical model may be configured to provide a probability that an emotional state of a subject is improving or deteriorating. The statistical model may be in the form of a probabilistic model, preferably utilising Bayesian analysis or statistical methods to determine probabilities of emotional states of the subject. The statistical model may be in the form of a Bayesian network.

A reporting means may be provided for reporting to the user, preferably in real time during a conversation with the subject, the recorded speech characteristics of the subject's speech, the classified text and speech characteristics, the emotional state of the subject and/or the improving or deteriorating emotional state of the subject for allowing the user to respond and adapt accordingly so as to maintain the subject in a more positive emotional state. The reporting means may be arranged in communication with the receiving means, converting means, recording means, classifying means and/or analysing means for allowing receipt and/or transfer of data therefrom.

The receiving means, converting means, recording means, classifying means, analysing means and/or reporting means may be in the form of a plurality of interconnected processors, which processors may be located remote from each other. Preferably the receiving means, converting means, recording means, classifying means, analysing means and/or reporting means may be integrally formed into a single processor which may be arranged in communication with the speech sensor. The single processor may be in the form of or form a part of any device of the group including a computer, mobile phone, tablet, watch, and smart device.

The single processor may be configured to create a subject profile which may be stored on the data storage means, preferably forming a database containing a plurality of subject profiles for future access. The subject profile may include records of previous conversations with the subject, which records may include detailed information on sensed, recorded and/or classified text and speech characteristics of the subject during the previous conversations. The subject profile may include a record of phrases which caused deterioration of an emotional state of the subject as well as possible phrases to be used by the user during conversation with the subject to improve the emotional state of the subject. The subject profile may be configured to be used for any one or more of the group including maintenance of historical records, auditing and security purposes, analysis, and data mining.

According to a second aspect of the invention, there is provided a method for determining an emotional state of a subject, which method includes:

sensing a subject's speech utilising a speech sensor;

receiving the sensed speech by a receiving means arranged in communication with the speech sensor;

converting the sensed speech into text;

classifying the text and speech characteristics of the subject's speech according to a predetermined set of human emotions; and

analysing the classified text and speech characteristics so as to determine an emotional state of the subject.

### BRIEF DESCRIPTION OF THE DRAWINGS

A system for determining an emotional state of a subject in accordance with the invention will now be described by way of the following, non-limiting examples with reference to the accompanying drawing.

In the drawings:

FIG. 1 is a schematic showing a process diagram of the system for determining an emotional state of a subject in accordance with the present invention;

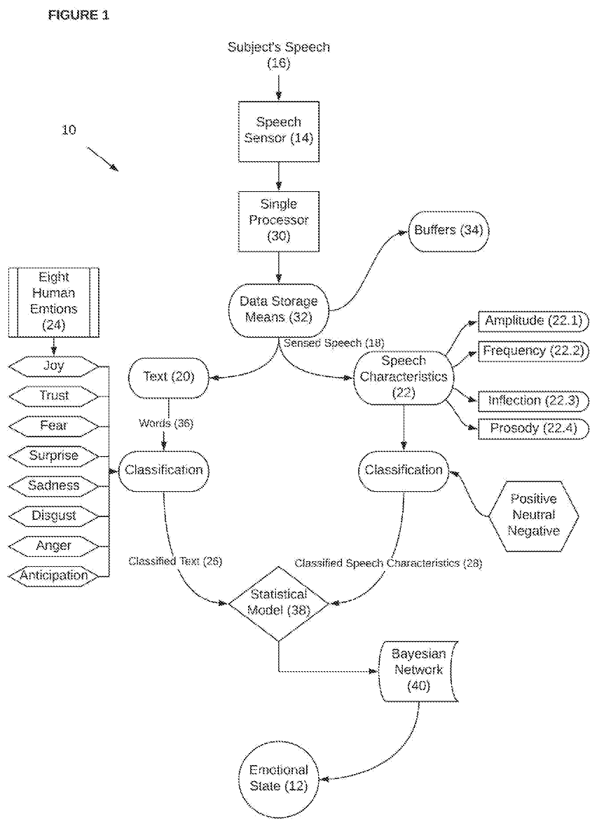

FIG. 2 is a further schematic showing process flow diagram of the system; and

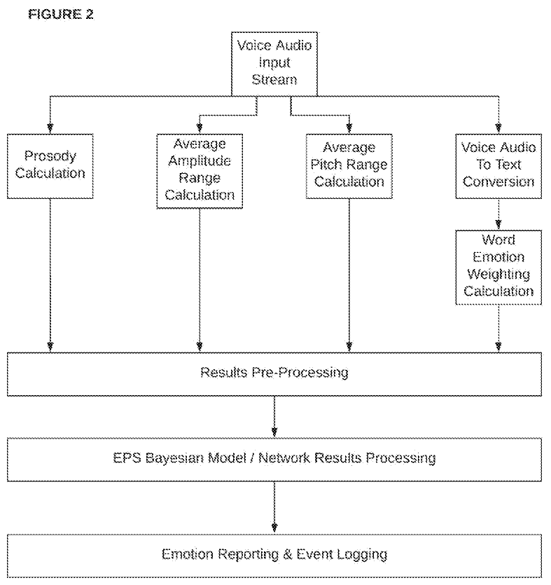

FIG. 3 is a schematic showing a process diagram of the statistical model used in the system.

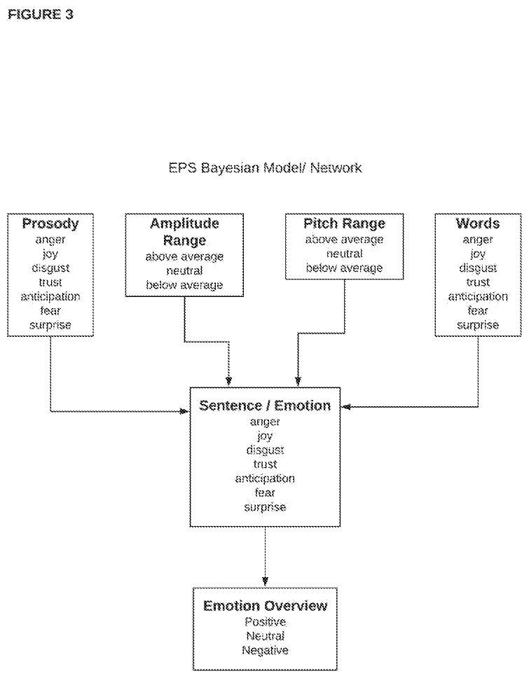

### DETAILED DESCRIPTION OF THE INVENTION

Referring now to the drawings, reference numeral 10 refers generally to a system for determining an emotional state 12 of a subject.

The system 10 for determining an emotional state 12 of a subject includes a speech sensor 14 for sensing a subject's speech 16, a receiving means arranged in communication with the speech sensor 12 for receiving the sensed speech 18 thereby, a converting means for converting the sensed speech 18 into text 20, a classifying means for classifying the text 20 and speech characteristics 22 of the subject's speech 16 according to a predetermined set of human emotions 24, and an analysing means for analysing classified text 26 and classified speech characteristics 28 so as to determine the emotional state 12 of the subject.

The speech sensor 14 is in the form of any suitable conventional sound sensor for sensing and converting sound into electrical signals.

The receiving means may be arranged in communication with a data storage means 32 for allowing the sensed speech 18 to be stored and captured thereon. The data storage means 32 can be in the form of any one or more of the group including an external hard drive or magnetic type hard drive, a solid-state drive, a network attached storage, a flash or USB drive and an optical drive. The data storage means 32 includes a plurality of buffers 34 which are configured to receive and store the sensed speech 18. A buffer 34 has a size so as to be capable of receiving and storing all sensed speech of a subject during conversation between a user and the subject. In particular, the buffers 34 have a size of 900 000 bytes for allowing an audio file of duration in the range of 7 to 15 seconds to be stored. More particularly, the duration of the audio file corresponds to a duration of a sentence or conversation.

The converting means is configured to convert the sensed speech 18 into text 20 utilising any suitable conventional speech to text conversion technique or method. In particular, the converting means is configured to convert the sensed speech 18 into a sequence of words 36. The converting means is further configured to continuously convert the sensed speech 16 into text 20 such that an entire conversation between a user and the subject is capable of being converted into text 20.

A recording means is arranged in communication with the speech sensor 14 for allowing the sensed speech 18 to be recorded. The recording means is configured to continuously record and monitor the speech characteristics 22 of the subject's speech throughout the duration of a conversation with the subject. The speech characteristics 22 of the subject's speech 16 includes any one or more of the group including amplitude or loudness 22.1, frequency or pitch 22.2, inflection 22.3 and prosody 22.4, inflection, pronunciation, grammar, and vocabulary. Prosody 22.4 typically includes patterns of a variety of linguistic nuances such as intonation, tone, emphasis, stress, accent and rhythm. It is to be appreciated that prosody can be specific to a particular subject and typically reflects physiological and habitual aspects of the subject. Prosody 22.4 can be capable of indicating an identity of a subject.

The recording means is configured to record prosody 22.4 by extracting any one or more sound features of the group including pitch, amplitude, energy, zero crossing rate, entropy of energy, spectral centroid, spectral entropy, spectral flux, spectral roll-off, mel-frequency cepstral coefficients (MFCCs), chroma vector, chroma deviation, and duration from the sensed speech 18. Extraction of the sound features by the recording means is carried out via any suitable extraction method such as, for example, short-term or mid-term feature extraction. It is to be appreciated that short-term feature extraction is carried out by splitting a sound signal into a plurality of frames or segments and measuring aspects of the sound signal in a frame so as to compute and extract any one or more of the above features in the frame. Further, mid-term feature extraction includes a statistical analysis of the features extracted during short-term feature analysis. The sound features are typically located in a region commonly known in the art as prosodic contour or boundary. The prosodic contour typically extends over a plurality of syllables and may be segmented into pseudo syllabic regions. The pseudo syllabic regions are modeled using any one or more of the above sound features, typically being in the form of feature vectors. Feature vectors are in the form of any one or more of the group including a change in energy which is computed using a difference in maximum and minimum energy in a frame, average jitter which is computed using the variation in frequency for a particular cycle and average shimmer which is computed using a variation in peak-to-peak amplitude. Prosodic contours or boundaries are in the form of prosodic word boundaries or prosodic phrase boundaries.

For the purposes of this specification, the following terms are defined.

Spectral centroid is to be understood as a measure used in digital signal processing to characterise a spectrum. It indicates where the “center of mass” of the spectrum is located. It is calculated as a weighted mean of frequencies present in the signal. Spectral entropy is to be understood as an indication as to the complexity of a signal. Spectral flux is to be understood as a rate of change of power of a spectrum. Spectral roll-off is to be understood as a steepness of a transmission function with frequency. A mel-frequency cepstral co-efficient is to be understood as a representation of a short-term power spectral of a sound. Chroma vector is to be understood as a vector quantifying a chroma feature which is used to relate different pitches of sound. Chroma deviation is to be understood as changes in chroma relating to variation of tone or expression in sound.

Zero crossing rate is to be understood as the rate at which a sound signal changes between positive and negative. Prosodic contour is to be understood as the manner in which patterns of prosodic features (excluding voice quality) vary during speaking or uttering, which prosodic features include intensity, fundamental frequency, speech rate and rhythm. Feature vectors are to be understood as vectors which are n-dimensional vectors of numerical features, the nth degree being dependant on the number of vectors used. The representation of sound features as feature vectors is to facilitate the process of machine learning as it is a numerical representation of a combination of objects that are pertinent to the facilitation of processing and statistical analysis. Prosodic word or phrase boundaries are to be understood as segments of spoken word that have particular prosodic patterns comprised of the aforementioned elements (intensity, fundamental frequency, speech rate and rhythm).

The classifying means is arranged in communication with the converting means for allowing receipt of text 20 therefrom. The classifying means is configured to classify individual words 36 of the text 20 according to the predetermined set of human emotions 24. The predetermined set of human emotions 24 are selected from the group including joy, trust, fear, surprise, sadness, disgust, anger, and anticipation, which group is typically based on Robert Plutchik's wheel of emotions.

The classifying means is further configured to classify the words 36 according to a scale which is adapted to indicate correlations between a word 36 and an emotion 24. The scale (not shown) is in the form of a binary scale (not shown) having eight digits which are configured to correspond to the predetermined set of eight human emotions 24. The binary scale (not shown) is configured such that a one represents a correlation between the word and the emotion, and a zero represents an absent correlation between the word and the emotion. The scale (not shown) includes a further two digits for representing sentiment of a particular word 36. The first digit represents negative sentiment and the second digit represents positive sentiment, such that a one indicates a negative and positive sentiment of a word 36, respectively, and a zero indicates neutral sentiment. More particularly, the classifying means is configured to classify the words 36 of the text 20 according to the NRC (National Research Council Canada) Word-Emotion Association Lexicon.

The classifying means is yet further configured to compare the recorded speech characteristics 22 to characteristic references (not shown) for allowing a user to determine a change in speech characteristics 22 of the subject's speech 18 relative the characteristic references during a conversation with the subject. The characteristic reference is an average which is measured towards a beginning of a conversation with the subject and which is measured over a predetermined period of time, typically being thirty seconds. The classifying means is configured to classify the recorded speech characteristic 22 according to a characteristic scale. The characteristic scale includes three categories, namely, negative, neutral and positive, typically being represented by the values −1, 0 and 1, respectively, which indicate a decrease, constant and increase in the particular speech characteristic 22, respectively. The classifying means is configured to account for characteristics unique to a particular subject. Additionally, the classifying means is configured to account for a particular audio transmitting device used by the particular subject. Speech characteristics such as amplitude 22.1 and frequency 22.2 are classified according to such a characteristic scale. Alternatively, the characteristic reference is in the form of characteristic patterns which may be specific to a particular subject, which patterns are measured and recorded during conversation with the subject.

More particularly, the recorded amplitude 22.1 is compared to an amplitude reference (not shown) for allowing a user to determine a change in amplitude or loudness (not shown) of the subject's speech 18 during a conversation with the subject relative to the amplitude reference, which change typically indicates a change in emotional state 12 of the subject. The amplitude reference (not shown) is an average amplitude of the subject's speech 18, which average amplitude is measured towards a beginning of a conversation with the subject and is typically measured over a period of thirty seconds. The classifying means is configured to classify the recorded amplitude 22.1 according to an amplitude scale (not shown). The amplitude scale (not shown) includes three categories, namely, negative, neutral and positive, typically being represented by the values −1, 0 and 1, respectively, which represent a decrease, constant and an increase in amplitude, respectively.

The recorded frequency 22.2 is compared to a frequency reference (not shown) for allowing a user to determine a change in frequency or pitch of the subject's speech during a conversation with the subject relative to the frequency reference, which change typically indicates a change in emotional state 12 of the subject. The frequency reference (not shown) is an average frequency of the subject's speech 16, which average frequency is measured towards a beginning of a conversation with the subject and is typically measured over a period of thirty seconds. The classifying means is configured to classify the recorded frequency 22.2 according to a frequency scale (not shown). The frequency scale (not shown) includes three categories, namely, negative, neutral and positive, typically being represented by the values −1, 0 and 1, respectively, which represent a decrease, constant and an increase in frequency 22.2, respectively.

Further, the recorded inflection and prosody 22.3 and 22.4 respectively, are compared to references in the form of patterns, which are specific to a particular subject. The reference patterns of inflection and prosody of a particular subject are calculated during recording thereof during conversation with the particular subject.

The analysing means is arranged in communication with the classifying means for allowing receipt of the classified text 26 and speech characteristics 28 therefrom. The analysing means is configured to input the classified text and speech characteristics 26 and 28, respectively, into a statistical model 38 for determining the emotional state 12 of the subject at any given time during conversation with the subject. The statistical model 38 is configured to provide a probability that an emotional state 12 of a subject is improving or deteriorating. The statistical model 38 is in the form of a probabilistic model which utilises Bayesian analysis or statistical methods to determine probabilities of emotional states of the subject. The statistical model 38 is typically in the form of a Bayesian network 40. It is to be appreciated that the classified text 26 and speech characteristics 28 can be further analysed to detect when a subject is being dishonest during conversation.

A reporting means is provided for reporting to the user, typically in real time during a conversation with the subject, the recorded speech characteristics 22 of the subject's speech 18, the classified text and speech characteristics 26 and 28, respectively, the emotional state 12 of the subject or the improving or deteriorating emotional state of the subject for allowing the user to respond and adapt accordingly so as to maintain the subject in a more positive emotional state. The reporting means is arranged in communication with the receiving means, converting means, recording means, classifying means and analysing means for allowing receipt of data therefrom.

The receiving means, converting means, recording means, classifying means, analysing means and reporting means are integrally formed into a single processor which may be arranged in communication with the speech sensor. The single processor may be in the form of any a device of the group including a computer, mobile phone, tablet, watch, and smart device.

The single processor 30 is configured to create a subject profile (not shown) which is typically stored on the data storage means 32, typically forming a database (not shown) containing a plurality of subject profiles for future access. The subject profile (not shown) includes records of previous conversations with the subject, which records include detailed information on recorded and classified text 20 and 26, respectively, and recorded and classified speech characteristics 22 and 28, respectively, of the subject during the previous conversations. The subject profile (not shown) further includes a record of phrases which previously caused deterioration of an emotional state of the subject as well as possible phrases to be used by the user during conversation with the subject to improve the emotional state of the subject. The subject profile (not shown) is configured to be used for any one or more of the group including maintenance of historical records, auditing and security purposes, analysis, and data mining.

It is, of course, to be appreciated that the system for determining an emotional state of a subject in accordance with the invention is not limited to the precise constructional and functional details as hereinbefore described with reference to the accompanying drawings and which may be varied as desired.

The inventor believes that the system for determining an emotional state of a subject in accordance with the present invention is advantageous in that it provides a means for companies to monitor an emotional state of a customer, client or the like and allows workers in the companies to adapt or respond accordingly during telephone conversations with customers, clients or the like, so as to ensure customer and client satisfaction.

1. A system for determining an emotional state of a subject, which system includes:
a speech sensor for sensing a subject's speech;
a receiving means arranged in communication with the speech sensor for receiving the sensed speech;
a converting means for converting the sensed speech into text;
a classifying means for classifying the text and speech characteristics of the subject's speech according to a predetermined set of human emotions; and
an analysing means for analysing the classified text and speech characteristics so as to determine an emotional state of the subject.

2. A system as claimed in claim 1 wherein the receiving means is arranged in communication with a data storage means for allowing the sensed speech to be stored thereon.

3. A system as claimed in claim 2 wherein the data storage means includes a plurality of buffers which are configured to receive and store the sensed speech.

4. A system as claimed in claim 3 wherein the buffers have a size so as to be capable of storing sensed speech of a subject during a conversation between a user and a subject.

5. A system as claimed in claim 4 wherein the converting means is configured to convert the sensed speech into a sequence of words.

6. A system as claimed in any one or more of the preceding claims wherein the converting means is configured to continuously convert the sensed speech into text such that an entire conversation between a user and the subject is capable of being converted into text.

7. A system as claimed in any one or more of the preceding claims wherein a recording means is arranged in communication with the speech sensor for allowing the sensed speech to be recorded.

8. A system as claimed in claim 7 wherein the recording means is configured to record the speech characteristics of the subject's speech throughout a duration of a conversation with the subject.

9. A system as claimed in claim 7 or 8 wherein the recording means is configured to continuously record the speech characteristics throughout a duration of a conversation with the subject.

10. A system as claimed in any one or more of the claims 7 to 9 wherein the speech characteristics include any one or more of the group including amplitude, frequency, inflection, pronunciation, prosody, grammar, and vocabulary.

11. A system as claimed in any one or more of the claims 7 to 10 wherein the recording means is configured to record prosody by extracting any one or more sound features of the group including pitch, amplitude, energy, zero crossing rate, entropy of energy, spectral centroid, spectral entropy, spectral flux, spectral roll-off, mel-frequency cepstral coefficients (MFCCs), chroma vector, chroma deviation, and duration, from the sensed speech.

12. A system as claimed in any one or more of the preceding claims wherein the classifying means is arranged in communication with the converting means for allowing receipt of text therefrom.

13. A system as claimed in claim 12 wherein the classifying means is configured to classify individual words of the text according to the predetermined set of human emotions.

14. A system as claimed in any one or more of the preceding claims wherein the predetermined set of human emotions are selected from the group including joy, trust, fear, surprise, sadness, disgust, anger, and anticipation.

15. A system as claimed in claim 14 wherein the predetermined set of human emotions are based on Robert Plutchik's wheel of emotions.

16. A system as claimed in any one or more of the claims 13 to 15 wherein the classifying means is configured to classify the words according to a scale which is adapted to indicate correlations between a word and an emotion.

17. A system as claimed in claim 16 wherein the scale is in the form of a binary scale.

18. A system as claimed in claim 17 wherein the binary scale has eight digits which correspond to the predetermined set of eight human emotions.

19. A system as claimed in claim 17 or 18 wherein the binary scale is configured such that a one represents a correlation between the word and the emotion, and a zero represents an absent correlation between the word and the emotion.

20. A system as claimed in any one or more of the claims 16 to 19 wherein the scale includes a further two digits for representing sentiment of a particular word.

21. A system as claimed in claim 20 wherein a first digit represents negative sentiment wherein and a second digit represents positive sentiment wherein a one indicates a negative and positive sentiment, respectively, and a zero indicates neutral sentiment.

22. A system as claimed in any one or more of the preceding claims wherein the classifying means is configured to classify words of the text according to the NRC (National Research Council Canada) Word-Emotion Association Lexicon.

23. A system as claimed in any one or more of the preceding claims wherein the classifying means is configured to compare sensed speech characteristics to characteristic references for allowing a user to determine a change in speech characteristics of the subject's speech relative the characteristic references during a conversation with the subject.

24. A system as claimed in claim 23 wherein the characteristic reference is an average which is measured towards a beginning of a conversation with the subject.

25. A system as claimed in claim 24 wherein the average is measured over a predetermined period of time.

26. A system as claimed in claim 25 wherein the predetermined period of time is thirty seconds.

27. A system as claimed in any one or more of the preceding claims wherein the classifying means is configured to classify sensed speech characteristic according to a characteristic scale.

28. A system as claimed in claim 27 wherein the characteristic scale includes three categories, namely, negative, neutral, and positive.

29. A system as claimed in claim 28 wherein the three categories are represented by the values −1, 0 and 1, respectively, which indicate a decrease, constant and an increase in the particular speech characteristic, respectively.

30. A system as claimed in any one or more of the claims 27 to 29 wherein speech characteristics such as amplitude and frequency are classified according to the characteristic scale.

31. A system as claimed in any one or more of the preceding claims wherein the classifying means is configured to account for characteristics unique to a particular subject.

32. A system as claimed in any one or more of the preceding claims wherein the classifying means is configured to account for a particular audio transmitting device used by the particular subject.

33. A system as claimed in any one or more of the preceding claims wherein the analysing means is arranged in communication with the classifying means for allowing receipt of the classified text and speech characteristics therefrom.

34. A system as claimed in any one or more of the preceding claims wherein the analysing means is configured to input classified text and speech characteristics into a statistical model for determining the emotional state of the subject at any given time during a conversation with the subject.

35. A system as claimed in claim 34 wherein the statistical model is configured to provide a probability that an emotional state of a subject is improving during a conversation with the subject.

36. A system as claimed in claim 34 wherein the statistical model is configured to provide a probability that an emotional state of a subject is deteriorating during a conversation with the subject.

37. A system as claimed in any one or more of the claims 34 to 36 wherein the statistical model is in the form of a probabilistic model.

38. A system as claimed in claim 37 wherein the probabilistic model utilises Bayesian analysis to determine probabilities of emotional states of the subject.

39. A system as claimed in any one or more of the claims 34 to 38 wherein the statistical model is in the form of a Bayesian network.

40. A system as claimed in any one or more of the preceding claims wherein a reporting means is provided for reporting to the user the sensed and recorded speech characteristics of the subject's speech, the classified text and speech characteristics, the emotional state of the subject and the improving or deteriorating emotional state of the subject for allowing the user to respond and adapt accordingly so as to maintain the subject in a more positive emotional state.

41. A system as claimed in claim 40 wherein the reporting means reports to the user in real time.

42. A system as claimed in claim 40 or 41 wherein the reporting means is arranged in communication with the receiving means, converting means, recording means, classifying means and analysing means for allowing receipt of data therefrom.

43. A system as claimed in any one or more of the preceding claims wherein the receiving means, converting means, recording means, classifying means, analysing means and reporting means are in the form of a plurality of interconnected processors.

44. A system as claimed in any one or more of the preceding claims wherein the receiving means, converting means, recording means, classifying means, analysing means and reporting means are integrally formed into a single processor which is arranged in communication with the speech sensor.

45. A system as claimed in claim 44 wherein the single processor is in the form of any device of the group including a computer, mobile phone, tablet, watch, and smart device.

46. A system as claimed in claim 44 or 45 wherein the processor is configured to create a subject profile which is stored on the data storage means for future access.

47. A system as claimed in claim 46 wherein the subject profile includes records of previous conversations with the subject, which records include detailed information on sensed, recorded and classified text and speech characteristics of the subject during the previous conversations.

48. A system as claimed in claim 46 or 47 wherein the subject profile includes a record of phrases which caused deterioration of an emotional state of the subject.

49. A system as claimed in any one or more of the claims 46 to 48 wherein the subject profile includes possible phrases to be used by the user during conversation with the subject to improve the emotional state of the subject.

50. A system as claimed in any one or more of the claims 46 to 49 wherein the subject profile is configured to be used for any one or more of the group including maintenance of historical records, auditing and security purposes, analysis, and data mining.

51. A system for determining an emotional state of a subject, according to the invention, substantially as hereinbefore described or exemplified.

52. A system for determining an emotional state of a subject, as specifically described with reference to or as illustrated in any one of the accompanying drawings.

53. A system for determining an emotional state of a subject, including any new or inventive integer or combination of integers substantially as herein described.

54. A method for determining an emotional state of a subject, which method includes:
sensing a subject's speech utilising a speech sensor;
receiving the sensed speech via a receiving means arranged in communication with the speech sensor;
converting the sensed speech into text;
classifying the text and speech characteristics of the subject's speech according to a predetermined set of human emotions; and
analysing the classified text and speech characteristics so as to determine an emotional state of the subject.
